(19) United States
(12) Patent Application Publication
(10) Pub. No.: US 2009/0006240 A1
(43) Pub. Date: Jan. 1, 2009

(54) System and Method of a Trading Room

(76) Inventors: Xirong Zhao, Fremont, CA (US); Wei Wang, Saratoga, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/771,948

(22) Filed: Jun. 29, 2007

(51) Int. Cl. G06Q 40/00

(52) U.S. Cl. 705/37

(57) ABSTRACT

A system of a trading room over a network and method thereof is described. The present invention solves problems of limited ability to demonstrate trading skills. A trading room system includes a user and trading room. A user may demonstrate trading and simultaneously share information with other users. It is an object of the present invention to provide simultaneous presentation of trading actions and information shared among users. An embodiment of the present invention allows different types of a user so as to allow a beginner user to learn from an experienced user.

### BACKGROUND OF INVENTION

1. Field of Invention

Aspects of the invention relate to electronic communication and more particularly to a system and method of demonstrating a transaction and communicating regarding the transaction over a network.

2. Background

Online trading facilitates individual investors' participation in the stock market. In the stock market, individual investors buy and sell ownership interests in publicly traded corporations. Such ownership interests may be traded through trading of shares and/or options of company stock, and/or trading of holding companies or mutual funds that own a portion of the company. Since the advent of online trading, the number of online brokerage accounts increased phenomenally.

A need exists for a system and method that can simultaneously display trading information and chat information so that users practice trading skills, view a transaction and/or demonstrate a transaction over a network. A need also exists for an online forum in which users can instantly share information with others while viewing a transaction. Accordingly, users can learn from watching the trading habits and techniques of other users.

There exist instant messengers and live chatting systems and methods over a network for purposes of educating users on stock and trading. However, existing products designed to offer education in trading are limited in their ability to demonstrate actual trades. Existing products are limited to the exchange of instant messages among users, which is difficult for users to follow.

Information relevant to addressing these problems may be found in existing products. However, each existing product suffers from one or more of the following disadvantages: inability to demonstrate real-time trading; inability to simultaneously share information with other users during trading; lack of personalized access to trading information depending on a user's trading experience and/or role in trading; lack of a forum where a user can learn trading skills from watching trading of others.

The existing products mentioned above are not admitted to be prior art with respect to the present invention by their mention in this Background Section.

### SUMMARY OF THE INVENTION

The present invention is directed to a system and a method of a trading room that satisfies the need to simultaneously display trading information and chat information so that users practice trading skills, watch a transaction and/or demonstrate a transaction over a network. The present invention is also directed to a system and a method of a trading room that offers an online forum in which users can instantly share information with others while watching a transaction, thereby users can learn from watching the trading of other users.

A computer system and method for a trading room over a network having features of the present invention comprises an interface between a user and the computer. The user is presented with an action or a plurality of actions of listing a candidate in a candidate display area, entering a position for the candidate, exiting a position for the candidate, and/or deleting the candidate listed. After the user selects the action, the action is recorded in the candidate display area. Simultaneously, an instant message is displayed on the interface and provided to the user to share information with another user. An embodiment of the present invention further allows different user types depending on the user's experience so that a beginner user can learn from an experienced user. The user types include a coach and a student—the coach may demonstrate trading and share information, and the student may participate in trading and share information.

An object of the present invention is to provide for education on trading. An embodiment of the present invention is a system, method, and apparatus which may be used as a teaching or educational tool for users. For example, the system at the control end allows a control user “coach” to demonstrate hypothetical stock trades to other users “students” while communicating with those users using the chat function. Additionally, another embodiment allows user “observers” to learn by observing the communications, but not participating. For example, a user “observer” may observe the demonstrated trades and communications between user “coaches and students”, but does not add to the communications.

An embodiment of the present invention includes three different types of users—a coach who demonstrates real time trading, a student who learns trading and practices trading, an observer who learns trading by viewing trading of others—and a trading room which enables a user to instantly send and receive trading information. A coach or a student uses a stock symbol, and an entry and/or exit price, and designates a type of trade, either long or short. A user remotely and instantly receives information at a trading room of his or her computer via a network connection. A user may exchange trading information using an instant message from and to a trading room.

An object of the present invention is to solve problems of limited ability to demonstrate trading skills by providing for efficient demonstration of trading without having to toggle between programs or windows. The present invention comprises a method and system to demonstrate a real-time trading. The method and system has an on-line forum to demonstrate trading and a forum for a user to exchange instant messages.

An embodiment of the invention enables a user to remotely watch, enter and exit a trade, to communicate in an on-line forum or chat room, and retrieve real-time information regarding trading. For example, the system enables a user to chat online while sharing stock trading information using real-time stock quotes without having to toggle between programs or windows on the computer.

In addition, an embodiment of the present invention allows a user to communicate trading information or reasoning by selecting standardized responses. For example, a user can simultaneously chat by entering text, see real-time stock quotes, and communicate reasons for a particular stock trade through a standardized response without toggling between programs or windows.

Implementations of the present invention include a method or process, an apparatus or system, or computer software on a computer-readable medium. In an embodiment of the present invention, there is a computer implemented method for a trading room connected to a network. The method comprising the steps of providing an interface between a user and the computer; presenting the user with at least one action, selected from action types comprising listing a candidate in a candidate display area, entering a position for the candidate, exiting a position for the candidate, and deleting the candidate listed; recording the action selected by the user in the candidate display area; providing a simultaneous instant message capability for the user to share information with another user; and displaying an instant message on the interface.

In another embodiment of the present invention there is a computer system for a trading room connected to a network including an interface between a user and the system. The system comprises one or more processors for executing commands that direct operations of the computer system; memory operatively coupled to the one or more processors; code executing within the one or more processors from the memory that directs the one or more processors to: provide an interface between a user and a computer system; provide a candidate display area to record an action selected by the user, wherein the action is selected from action types comprising listing a candidate in the candidate display area, entering a position for the candidate, exiting a position for the candidate, and deleting the candidate listed; provide a simultaneous instant message capability for the user to share information with another user; and provide a conversation display area to display an instant message.

In a further embodiment of the present invention, there is a computer-readable medium encoded with a computer program having computer-executable instructions configured to: provide an interface between a user and a computer system; provide a candidate display area to record an action selected by the user, wherein the action is selected from action types comprising listing a candidate in the candidate display area, entering a position for the candidate, exiting a position for the candidate, and deleting the candidate listed; provide a simultaneous instant message capability for the user to share information with another user; provide a conversation display area to display an instant message; and designate the user as either a coach or a student, wherein the coach is permitted to demonstrate trading and sharing of information, and wherein the student is permitted to participate in trading and sharing of information.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a screenshot of a trading room in general according to an embodiment of the present invention.

FIG. 2 is a screenshot of a trading room illustrating sending an instant message to a user according to an embodiment of the present invention.

FIGS. 3A to 3B are screenshots of a trading room illustrating listing a watch candidate according to an embodiment of the present invention.

FIGS. 4A to 4F are screenshots of a trading room illustrating entering a long position according to an embodiment of the present invention.

FIG. 5 is a screenshot of a trading room in which a short candidate is listed by using a candidates action box according to an embodiment of the present invention.

FIGS. 6A to 6B are screenshots of a trading room illustrating entering a long position according to an embodiment of the present invention.

FIG. 7A to 7C are screenshots of a trading room illustrating exiting a long position according to an embodiment of the present invention.

FIG. 8 is a screenshot of a trading room illustrating exiting a short position according to an embodiment of the present invention.

FIG. 9 is a screenshot of a trading room illustrating deleting a listing of a watch candidate according to an embodiment of the present invention.

FIG. 10 is a screenshot of a trading room illustrating how to change views according to an embodiment of the present invention.

### DETAILED DESCRIPTION OF SPECIFIC EMBODIMENTS

The description above and below and the drawings of the present document focus on one or more currently preferred embodiments of the present invention and describe some exemplary optional features and/or alternative embodiments. The description and drawings are for the purpose of illustration and not limitations. Those of ordinary skill in the art would recognize variations, modifications, and alternatives. Such variations, modifications, and alternatives are also within the scope of the present invention.

For purposes of illustration and not limitation, three kinds of users at the control end are illustrated in the drawings—a coach, a student, and an observer. A “coach” is a control user who demonstrates hypothetical trades to other users communicating with those users using the chat function. A coach is capable of displaying trading and leads the trading room by demonstrating trading. For example, a coach posts a stock trading transaction and sends information regarding such a transaction to be viewed by all users. Upon a coach's identifying a stock via a posting, the specific stock's technical chart is displayed on the screen for analysis purposes. A “student” is a user who learns trading skills from a coach. There may be a number of types of students, for instance, a “power student” and a “normal student.” A “power student” may participate in trading and chatting, whereas a “normal student” may participate only in chatting, but not trading. Additionally, another embodiment allows “observers,” users to learn by observing the communications, but not participate. For example, an observer may observe the demonstrated trades and communications between coaches and students, but cannot add to the communications.

For purposes of illustration and not limitation, a “position” refers to a long position (purchase) or a short position (sale); and a “long candidate” refers to a candidate trade for a long position whereas a “short candidate” refers to a candidate trade for a short position in trading.

An embodiment of the present invention may be embodied by way of a web-based application or computer software. In an embodiment of the present invention, selections may be made by clicking a specific button on a computer screen.

An embodiment of the present invention is capable of demonstrating instant trading actions. A user is able to instantly observe any trading action. For example, a trading room is directly linked to a live stock quote sheet and/or chart software such as Real Time Stock (RTS) software™. Upon identifying a stock in a trading room, the specific stock's technical chart is automatically displayed on the screen.

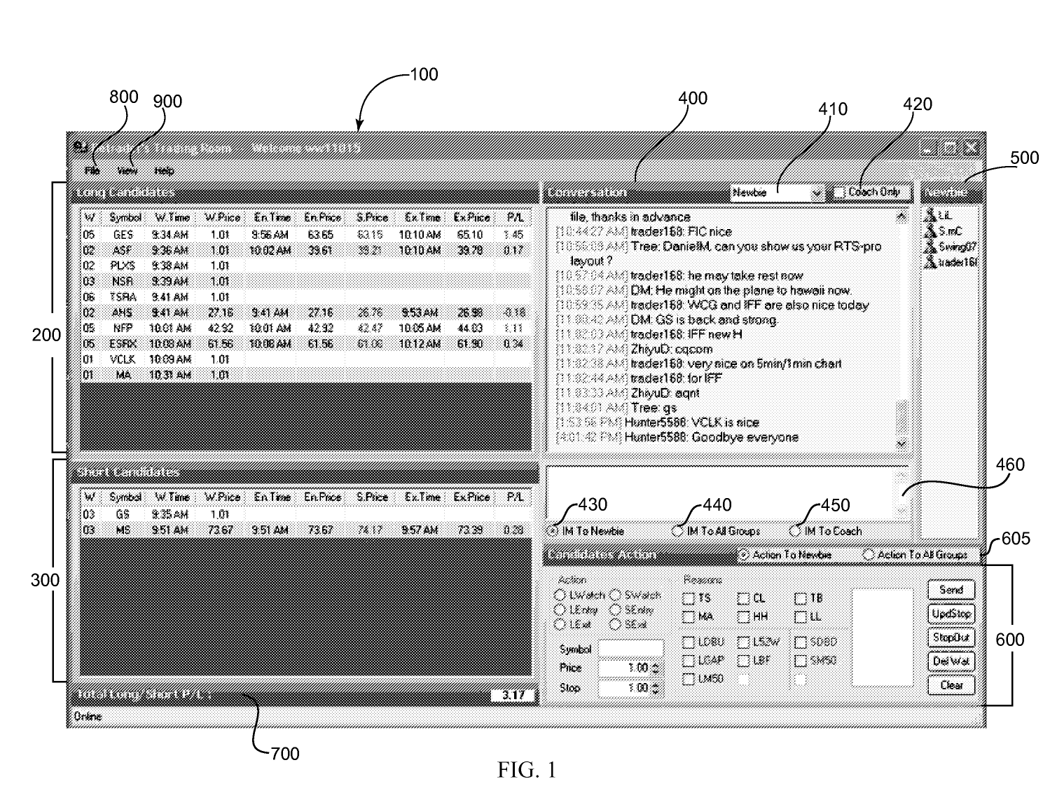

FIG. 1 is a screenshot of a trading room 100 in general according to an embodiment of the present invention. As illustrated in FIG. 1, the trading room 100 according to an embodiment of the present invention comprises a long candidates box 200, a short candidates box 300, a conversation box 400, a members online box 500, a candidates action box 600, and a total profit/loss box 700. The words “box” are used to designate an area or a display area where a certain action may occur and are not used in a literal sense of a box or window.

Long candidates box 200 displays a list of both long candidates which are being watched for trading, and long candidates for which a long position has already been entered. Short candidates box 300 displays a list of both short candidates which are being watched for trading, and short candidates for which a short position has been already entered. Conversation box 400 allows a user to type an instant message to share with other users and to view a message sent by a user. In an embodiment of the present invention, conversation box 400 also records every trading action taken. In members online box 500, all logged-on users are listed. Through candidates action box 600, a user may execute a trading action. Total profit/loss box 700 displays a summary of profit and loss of all transactions.

In an embodiment of the present invention, the system is protected by a login ID and a password. A login window pops up upon starting the program. A user may have a system automatically logon the user when the trading room 100 is started and skip entering the login ID and the password by opting to save the password.

In an embodiment of the present invention, accessible components vary depending on the user's role. A layout of a trading room is designed so as to maximize efficiency of the user's role in using the system. For instance, a trading room for a coach has a different layout from a trading room for a student.

An embodiment of the present invention provides four layouts of a trading room—one for a power student, one for a coach, one for a normal student and one for an observer. For example, the layout of a trading room for a coach includes all boxes shown in FIG. 1.

The boxes that are specifically available for only coaches in this embodiment of the present invention are as follows. A dropdown box 410 allows a coach to view different trading rooms for each group. In this embodiment of the present invention, there are two groups of normal students—a newbie group for normal students who have not completed a training course and a member group for advanced normal students who completed a training course. By choosing “newbie” in dropdown box 410, the coach may view all specific transactions and conversation that are displayed for the newbie group and a list of logged on members of the newbie group. A coach only box 420 displays conversation among coaches only. The options of IM to Newbie 430, IM to All Groups 440, and IM to Coach 450 allow a coach to direct an instant message to a specific group only by selecting the options. An option box 605 enables a coach to direct a certain transaction made through candidates action box 600 to a newbie group only or to all groups. The layout of a trading room for a power student includes all boxes except dropdown box 410, coach only box 420, IM to Newbie 430, IM to All Groups 440, IM to Coach 450, and option box 605.

The layout of a trading room for a normal student includes all boxes of a power student's except candidates action box 600. The layout of a trading room for an observer includes all boxes of a normal student's except an entry box 460 of conversation box 400.

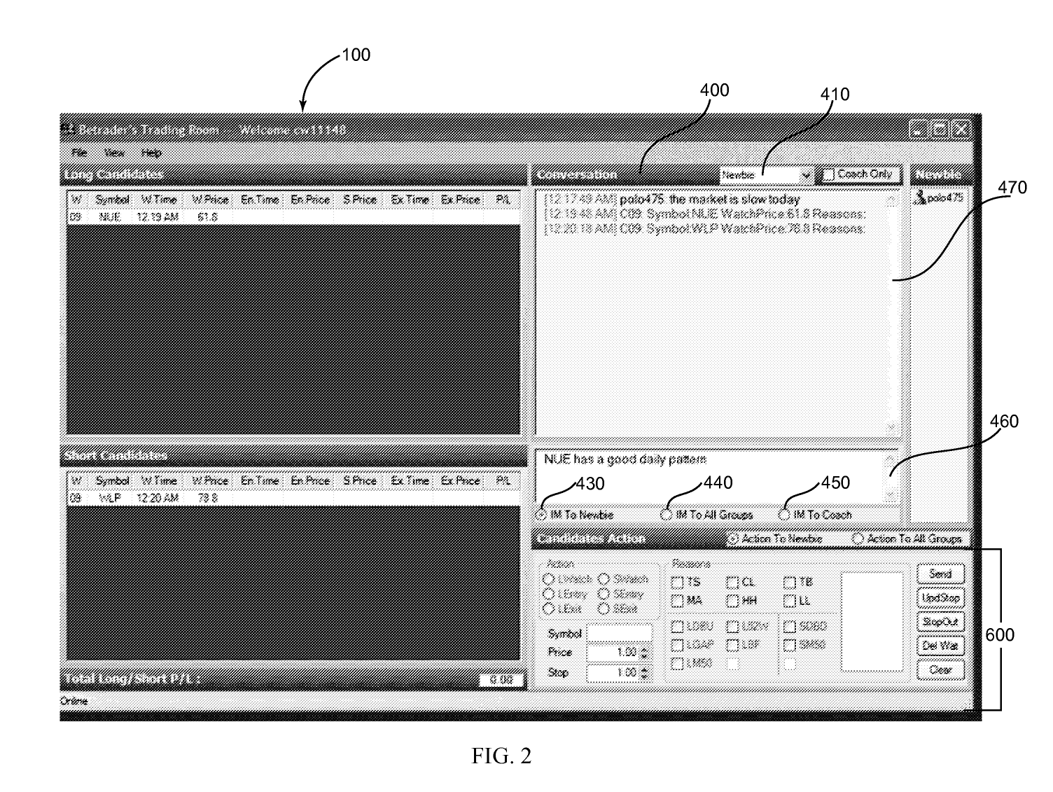

FIG. 2 is a screenshot of the trading room 100 illustrating sending an instant message to a user according to an embodiment of the present invention. As illustrated in FIG. 2, a user may type a message in entry box 460 and press an enter key for the message to be recorded in a message display box 470. Upon recording a message, the system automatically provides a time when the message was recorded and an ID of the user who recorded the message.

In an embodiment of the present invention, a coach may limit sharing an instant message only with other coaches by selecting coach only box 420. In an embodiment of the present invention, a sender of a message may selectively direct a specific message to a student by selecting, for example, IM to Newbie 430, to everybody by selecting IM to All Groups 440, or to a coach by selecting IM to Coach 450. In an embodiment of the present invention, a user can save a message log that took place in a specific session into a file for review.

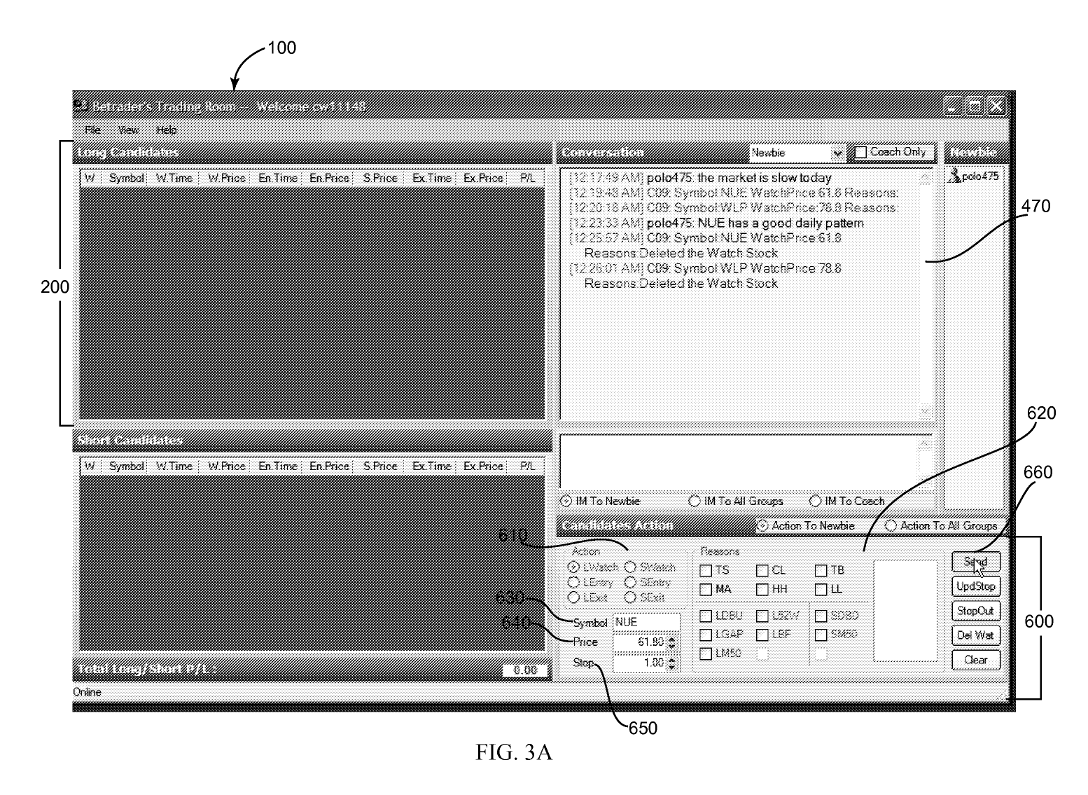

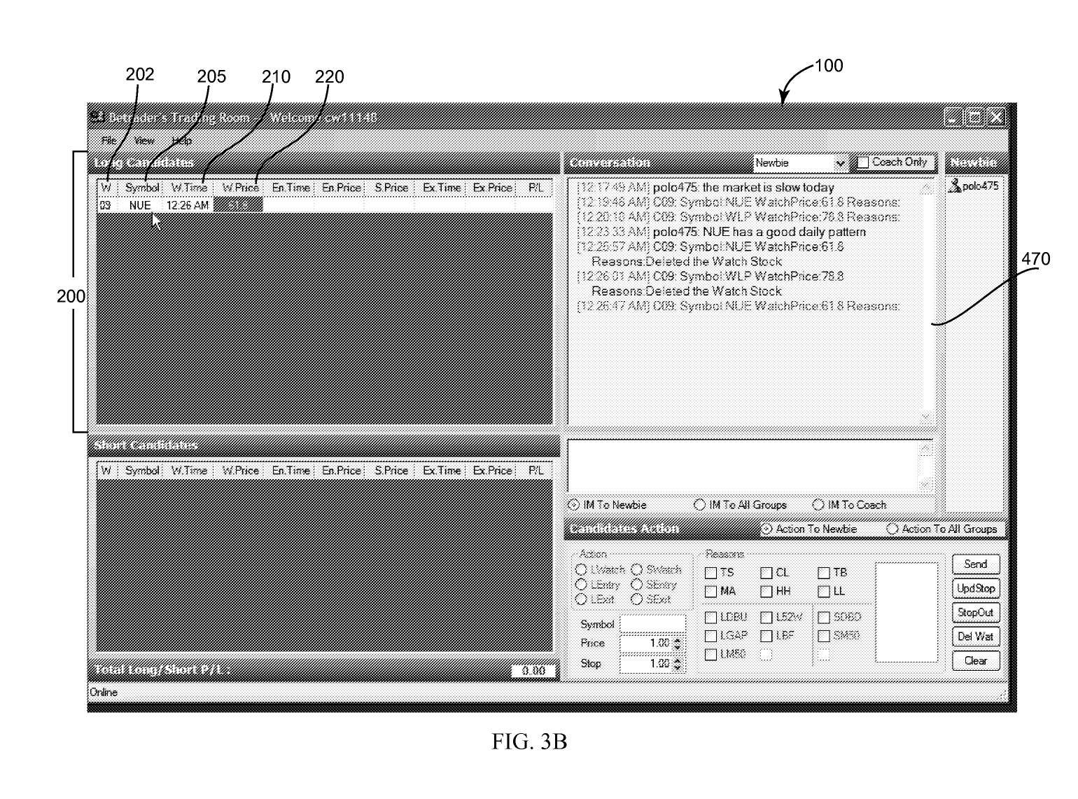

FIGS. 3A to 3B are screenshots of the trading room 100 illustrating listing a watch candidate according to an embodiment of the present invention. For the purpose of description and not limitation, a watch candidate means a candidate for trading of which a position has not been entered. FIG. 3A describes how to provide listing information in order to list a long watch candidate in long candidates box 200. A user may specify a type of action as watching a long watch candidate by selecting LWatch in an action box 610. The user then provides the symbol of a watch candidate stock in a symbol box 630, and a stock price at the time of watching the watch candidate stock in a price box 640. Optionally, the user may provide reasoning for the particular action by selecting a standardized reasoning from a reasons box 620. For example, reasons box 620 provides thirteen kinds of standardized reasoning—TS (trail stop) for an exercise price to account for a sudden change of a price within a general trend; CL (critical line) for an indicator which is generated using volume and volatility of data and, by comparing with the critical line, is used to predict whether a specific stock's market price is likely to go up or down; TB (trend box) for an indicator of a stock's tendency to move towards a particular target price; MA (moving average) for an average of a stock price over a certain time frame, which is used to analyze a trading trend, HH if a price is higher than the previous day's highest price; LL if a price is lower than the previous day's lowest price; LDBU (long candidate with daily break up) if a last price is greater than the highest price of a certain time frame; LGAP (long candidate with gap up) if an opening price is higher than the previous day's closing price; LM50 (long candidate above 50 MA) if a last price was higher than the moving average over the last 50 days and the previous day's closing price was lower than the moving average over the last 50 days; L52W if a long candidate's price is highest for the past 52 weeks; LBF (long bottom fisher) if a specific stock experiences a gap down and may have a chance to bounce back; SDBD (short candidate with daily break down) if a last price was less than the lowest price of a certain time frame; SM50 (short candidate below 50 MA) if a last price was lower than the moving average over the last 50 days and the closing price of the previous day was higher than the moving average over the last 50 days. In watching a long watch candidate, the user does not need to provide a stop price in a stop box 650, which may be used as a limit for a stock price for trading. The number 1.00 in stop box 650 is a default number that was provided in this embodiment of the present invention and does not affect the action of listing a long watch candidate. After providing the above information, the user may select a send button 660 to list a long watch candidate.

In an embodiment of the present invention, a current market price of a stock is automatically listed and updated and a user does not need to manually provide and update a market price.

FIG. 3B is a screenshot of the trading room 100, which resulted from selecting send button 660 after providing the listing information as described above for FIG. 3A. As illustrated in long candidates box 200 in FIG. 3B, this particular embodiment of the present invention provides the following information—W 202 for an individual ID of a member who entered the specific long watch candidate; Symbol 205 for the symbol of the specific long watch candidate entered; W.Time 210 for a watch time when the specific stock price was watched and recorded in the long watch candidates box 200; W.Price 220 for a watch price of the specific watch candidate stock at the watch time shown in W.Time 210.

In an embodiment of the present invention, all actions made through candidates action box 600 are recorded in message display box 470 as well as in long candidates box 200. As illustrated in message display box 470 of FIG. 3B, the system automatically provides a time when the specific action was taken, the ID of the user who listed the candidate, the symbol of the candidate, details of the specific action such as a price watch, and the reasons if provided.

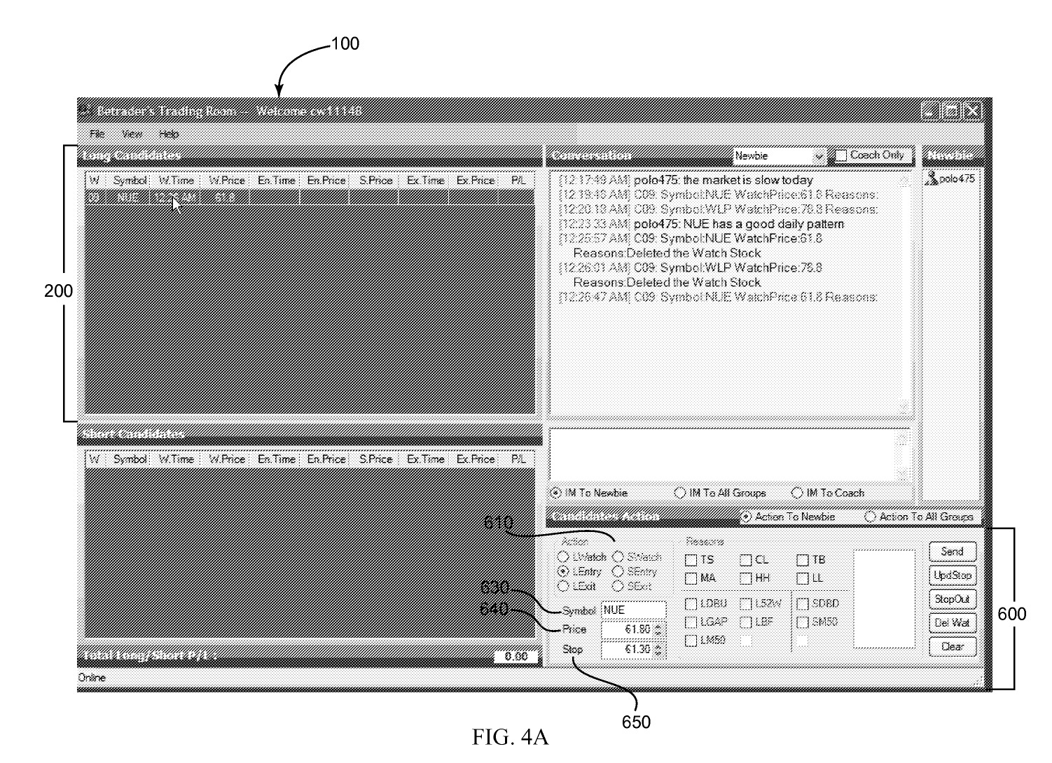

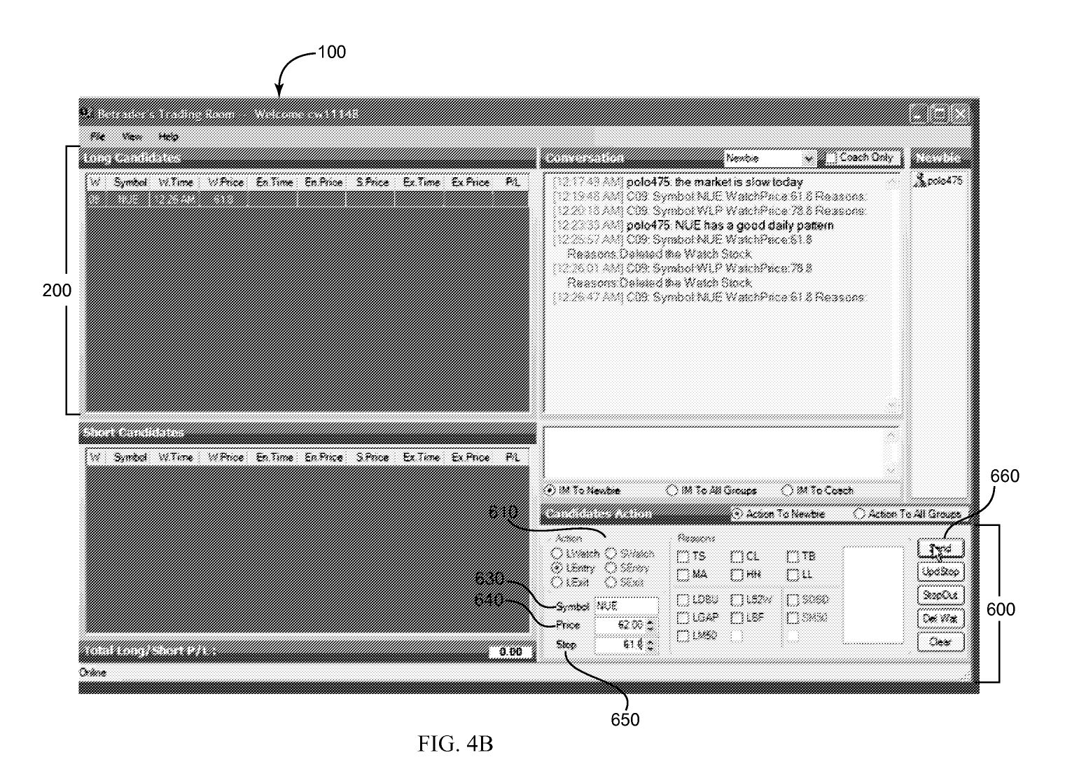

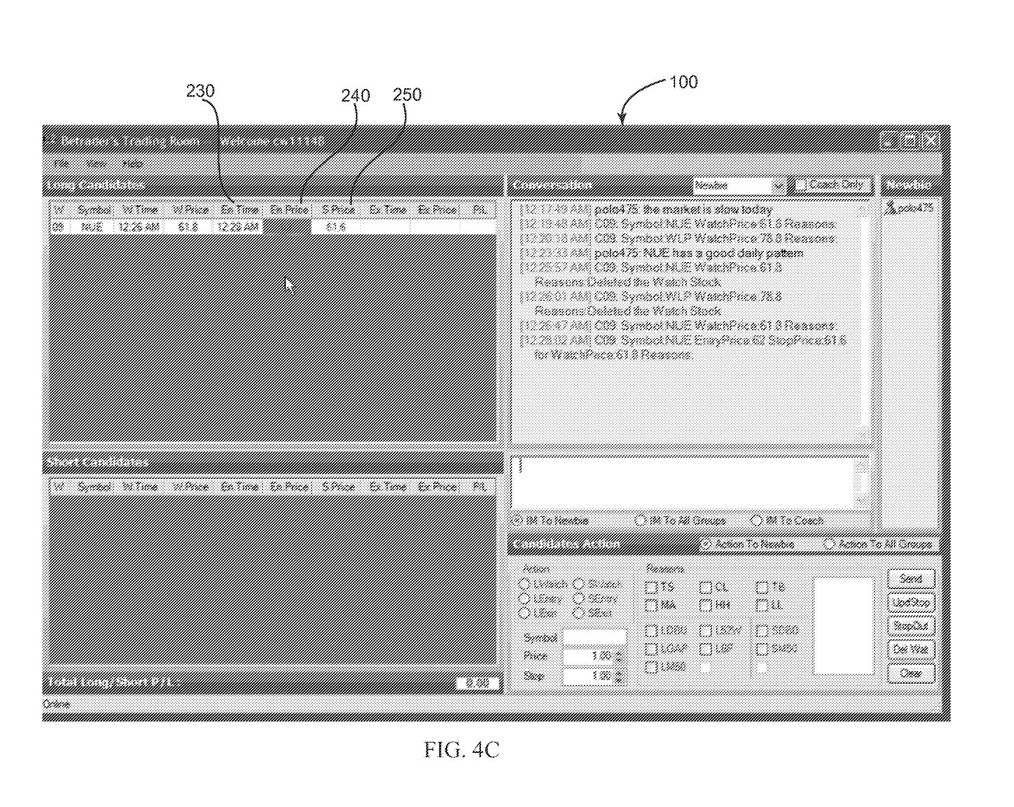

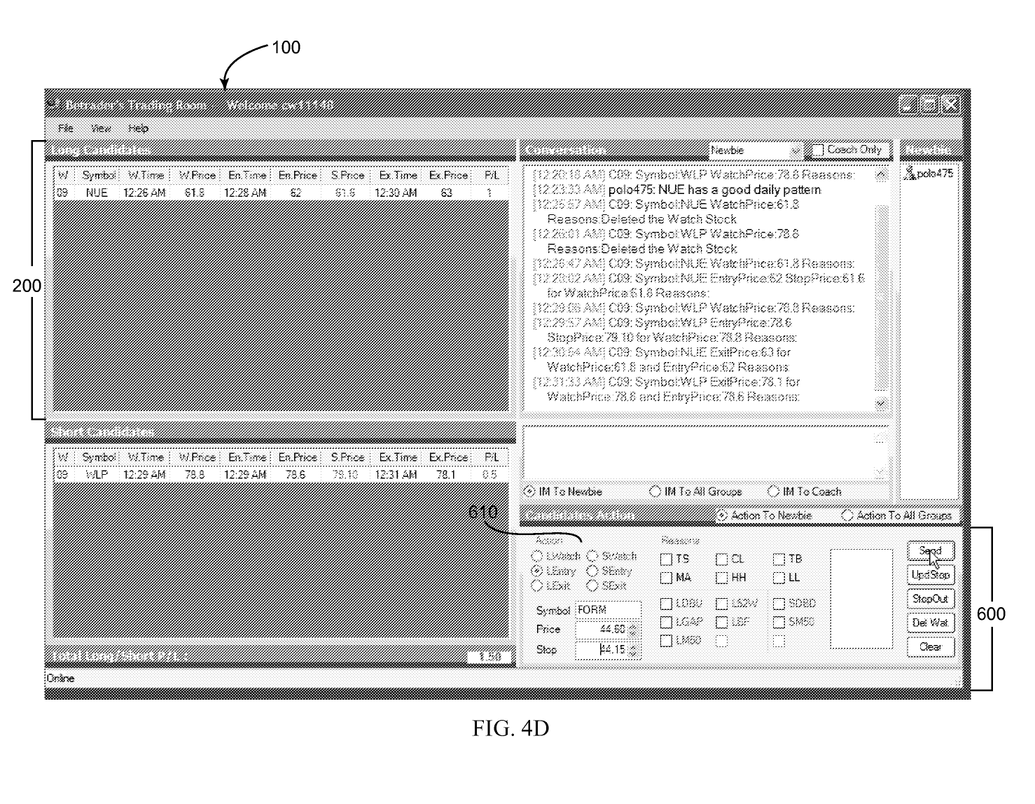

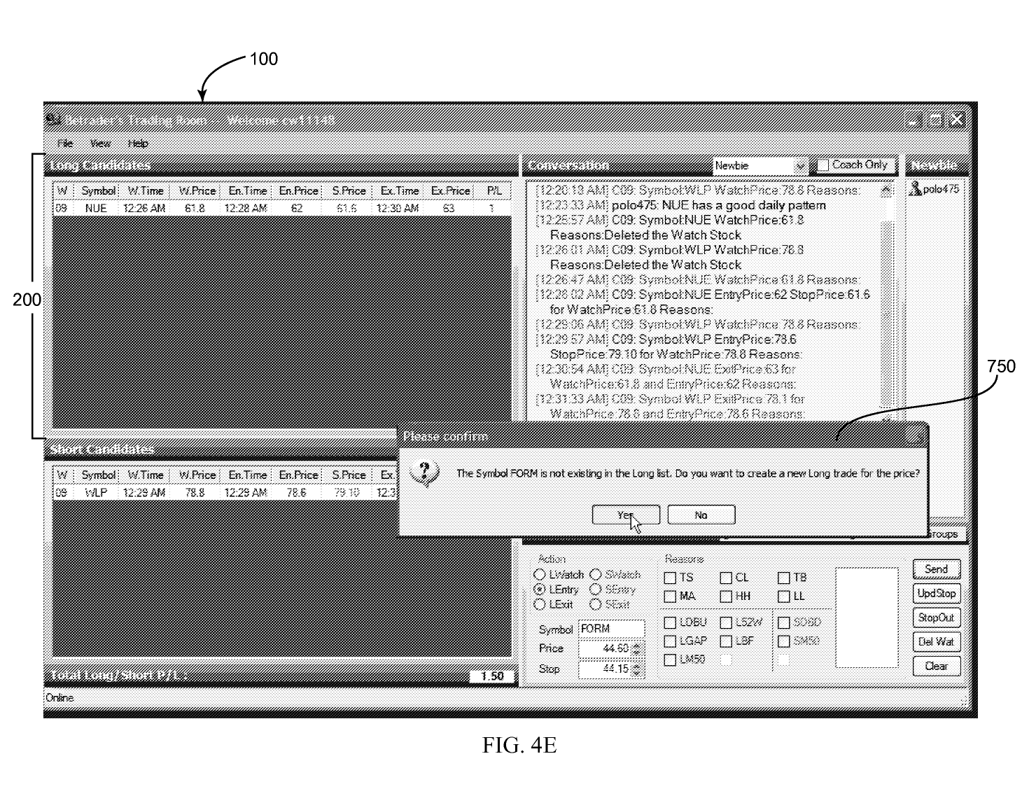

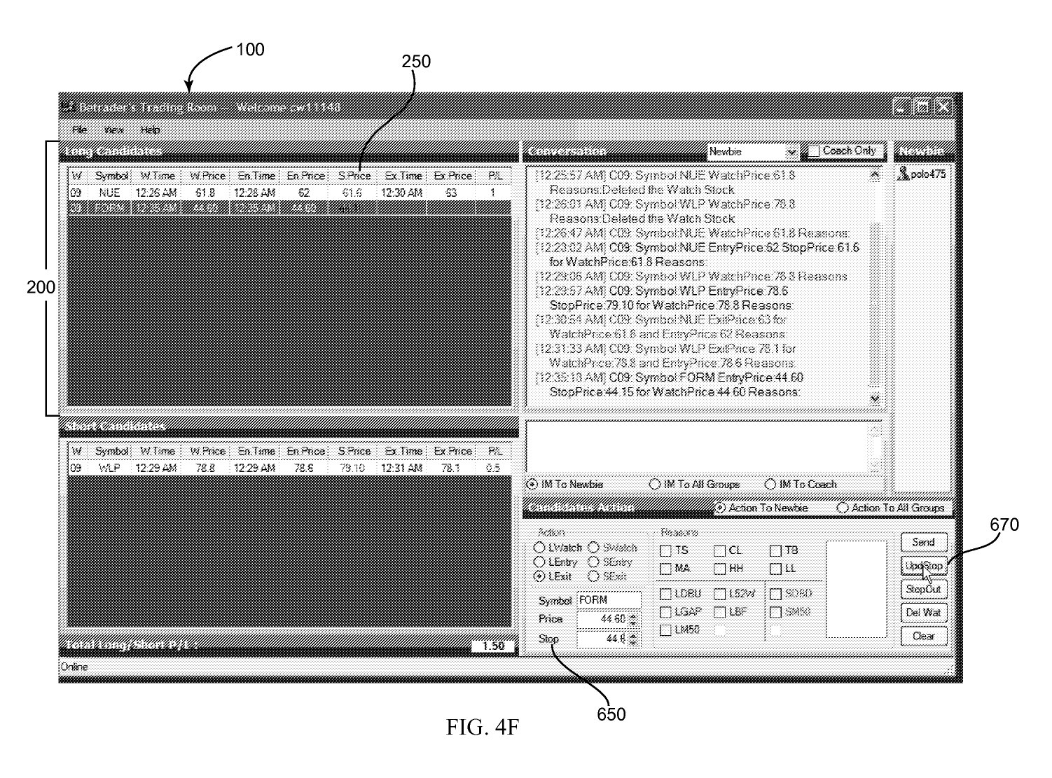

FIGS. 4A to 4E are screenshots of the trading room 100 illustrating entering a long position. In an embodiment of the present invention, after watching a long watch candidate's behavior, a coach or a student may decide to enter a long position. FIG. 4A illustrates how to initiate entering a long position and default settings according to an embodiment of the present invention. A user may initiate entering a long position by selecting the listing for a specific watch candidate in long candidates box 200. As shown in FIG. 4A, upon selecting, all information of the specific candidate in long candidates box 200 is highlighted; action box 610 of candidates action box 600 displays Lentry, which is already automatically selected; and symbol box 630 and price box 640 provide information shown in the listing information in long candidates box 200.

In an embodiment of the present invention, a user may have a default stop price entered in stop box 650, which automatically calculates a stop price from a number entered in price box 640. Different default stop prices may be set depending on an action type—whether the action is for a long position or a short position. For example, FIG. 4A illustrates an example of a default setting in a long entry position. A stop price is set 0.50 below a watch price. The user may change the default stop price by entering a different stop price in stop box 650.

FIG. 4B illustrates how to provide an entry price and a stop price to enter a long position in candidates action box 600 according to an embodiment of the present invention. The user provides an entry price, which is the purchase price of the specific long candidate, in price box 640 and a stop price, which is the limit price of the specific long candidate, in stop box 650. For example, as shown in FIG. 4B, the user may enter 62.00 as an entry price and 61.60 as a stop price. Upon providing all necessary information, the user selects send button 660 in order to display the entry information.

FIG. 4C is a screenshot of the trading room 100, which resulted from selecting send button 660 after providing the entry information as described above for FIG. 4B. As illustrated in long candidates box 200 in FIG. 4C, this particular embodiment of the present invention provides the following information in addition to the information provided in FIG. 3B—En.Time 230 for an entry time when the position for the specific stock price was entered in long candidates box 200; En.Price 240 for an entry price of the specific candidate stock; and S.Price 250 for a stop price of the specific candidate stock.

FIGS. 4D to 4E illustrate how a user enters a long position for a long candidate that was not previously listed in long candidates box 200. As illustrated in FIG. 4D, a user may specify the action as entering a long position by selecting LEntry in action box 610. The user then provides the symbol of a candidate stock in symbol box 630, a stock price at the time of watching the candidate stock in price box 640, and a stop price, the limit for a stock price for trading, in stop box 650. Optionally, the user may provide reasoning of the particular action by selecting a standardized response from reasons box 620. After providing the above information, the user may select send button 660 to enter a long position for the long candidate.

In an embodiment of the present invention, a message window 750, shown in FIG. 4E, pops up after the user presses send button 660 of FIG. 4D. Message window 750 of FIG. 4E queries whether the user wants to confirm the creation of a new long position for the candidate that was previously not listed in long candidates box 200. Upon selecting a yes button in message window 750, the new long position for the candidate is entered in long candidates box 200.

FIG. 4F illustrates how to update a stop price of a long candidate according to an embodiment of the present invention. A coach or a student may decide to change a stop price of a listed long candidate after watching the candidate's behavior in the market. A user initiates updating the previously entered stop price by selecting the listing for a specific candidate in long candidates box 200. As shown in FIG. 4F, the user provides a new stop price in stop box 650 and selects an “upd stop” button 670 in order to update the stop price entered. Upon selecting “upd stop” button 670, long candidates box 200 displays the updated stop price in the column of S.Price 250 accordingly.

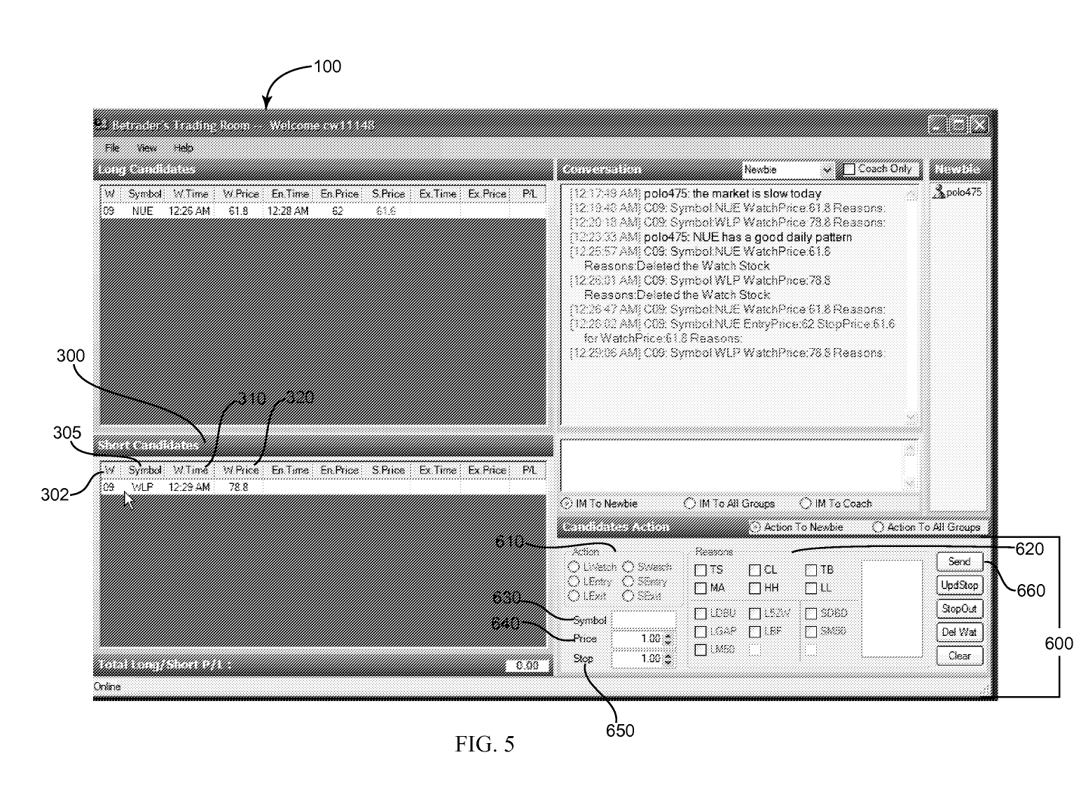

FIG. 5 is a screenshot of the trading room 100 in which a short watch candidate is listed in short candidates box 300 by using candidates action box 600 according to an embodiment of the present invention. In order to list a short watch candidate, a user provides listing information in candidates action box 600. Information is provided in a similar way as described for listing a long watch candidate in FIG. 3A. First, a user may specify the action as watching a short watch candidate by selecting SWatch in action box 610. The user provides the symbol of a watch candidate stock in symbol box 630, and a stock price at the time of watching the watch candidate stock in price box 640. Optionally, the user may provide reasoning of the particular action by selecting a standardized response from reasons box 620. In watching a short watch candidate, the user does not need to provide a stop price in stop box 650, which may be used as a limit for a stock price for trading. After providing the above information, the user may select send button 660 to list a short watch candidate.

FIG. 5 illustrates a resulting screenshot upon selecting send button 660. As illustrated in short candidates box 300, this particular embodiment of the present invention provides the following information—W 302 for an individual ID of a member who entered the specific short candidate; Symbol 305 for the symbol of the specific short candidate entered; W.Time 310 for a watch time when the specific stock price was watched and recorded in short candidates box 300; W.Price 320 for a watch price of the specific candidate stock at the watch time shown in W.Time 310.

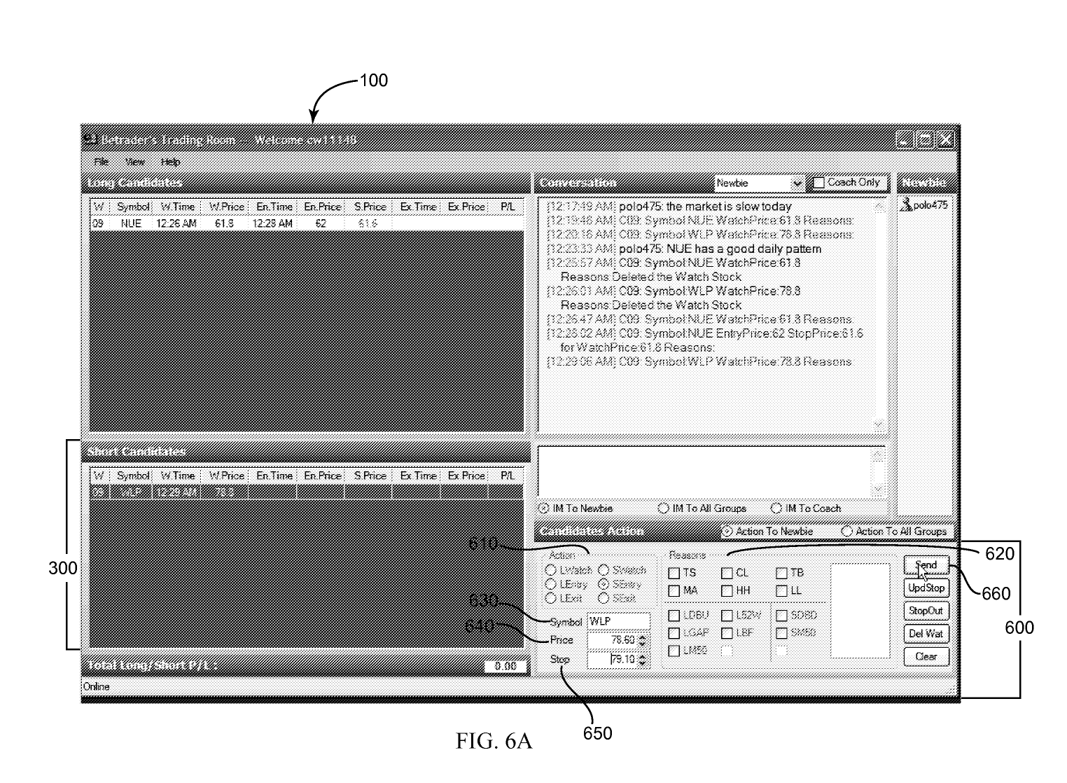

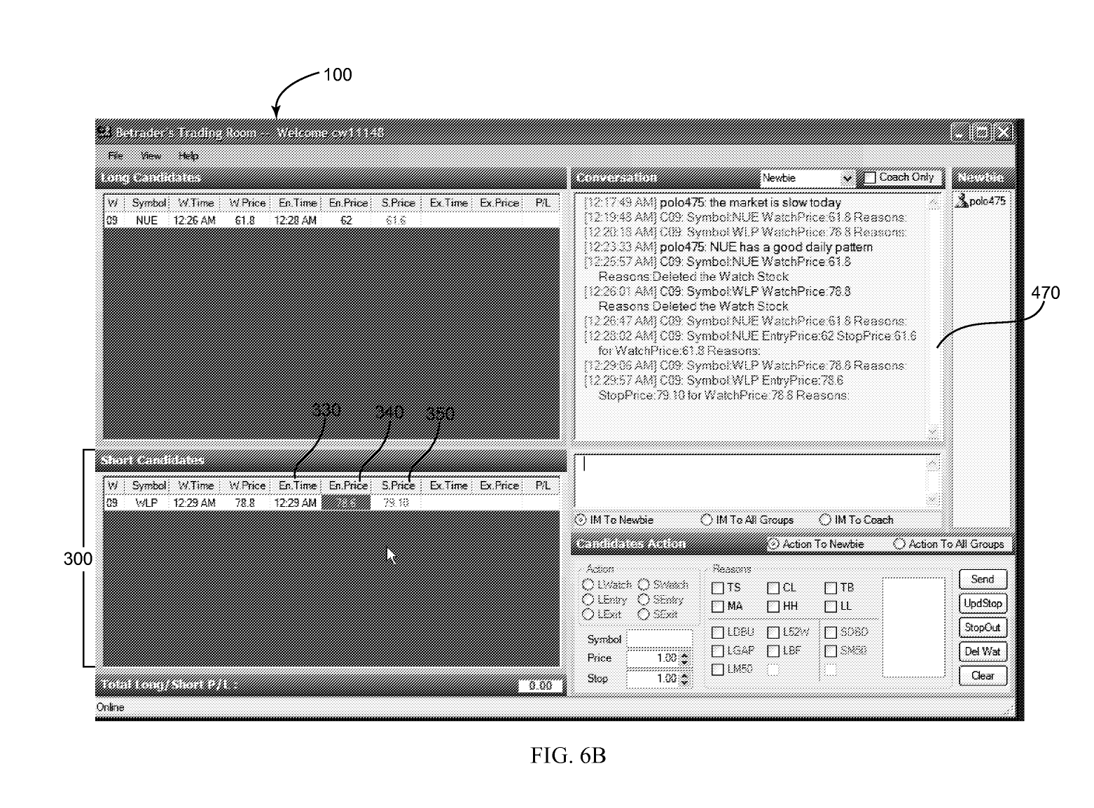

FIGS. 6A to 6B are screenshots of the trading room 100 illustrating entering a short position. In an embodiment of the present invention, after watching short candidates' behavior, a coach or a student may decide to enter a short position. A user initiates entering a short position by selecting the listing for a specific candidate in short candidates box 300. Upon selecting, all information of the specific candidate in short candidates box 300 is highlighted; action box 610 of candidates action box 600 automatically displays the selection of SEntry; and symbol box 630 and price box 640 provide information shown in the listing information in short candidates box 300, which is similar to the settings described for entering a long position in FIG. 4A.

FIG. 6A illustrates how to provide an entry price and a stop price to enter a short position in candidates action box 600 according to an embodiment of the present invention. The user provides an entry price, the sales price of the specific short candidate, in price box 640 and a stop price, the limit price of the specific short candidate, in stop box 650. For example, as shown in FIG. 6A, the user may enter 78.60 as an entry price and 79.10 as a stop price. Upon providing all necessary information, the user selects send button 660 in order to display the entry information.

FIG. 6B is a screenshot of the trading room 100, which resulted from selecting send button 660 after providing the entry information as described above for FIG. 6A. As illustrated in short candidates box 300 in FIG. 6B, this particular embodiment of the present invention provides the following information in addition to the information provided in FIG. 5—En.Time 330 for an entry time when the position for the specific stock was entered in short candidates box 300; En.Price 340 for an entry price of the specific candidate stock; S.Price 350 for a stop price of the specific candidate stock.

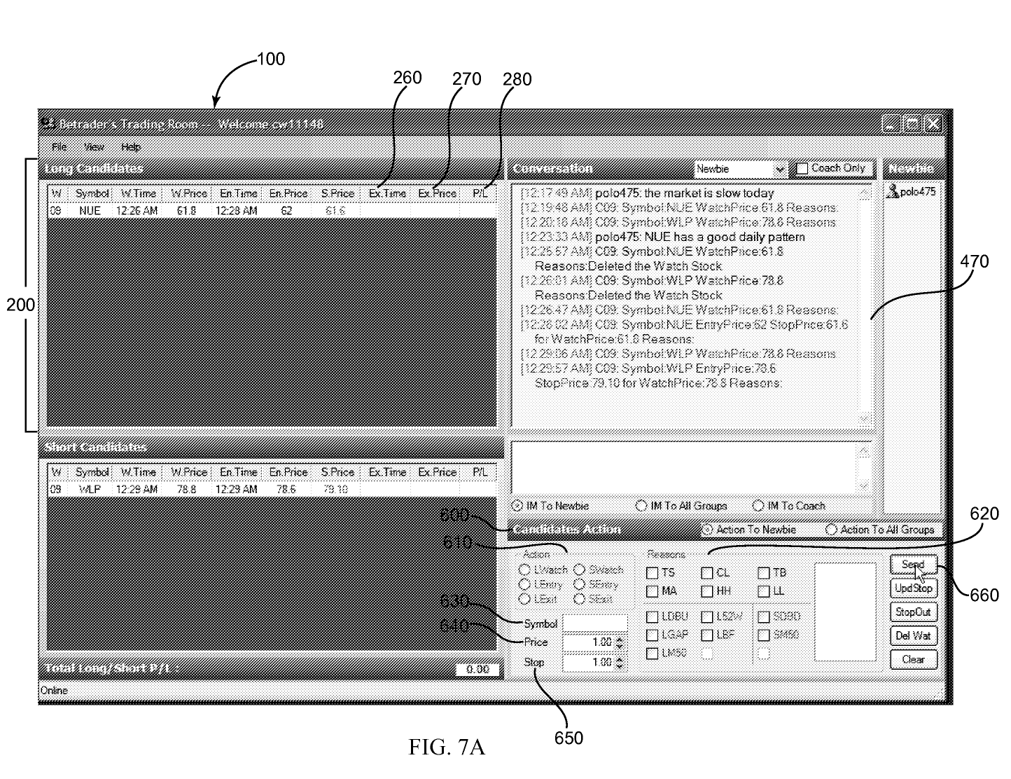

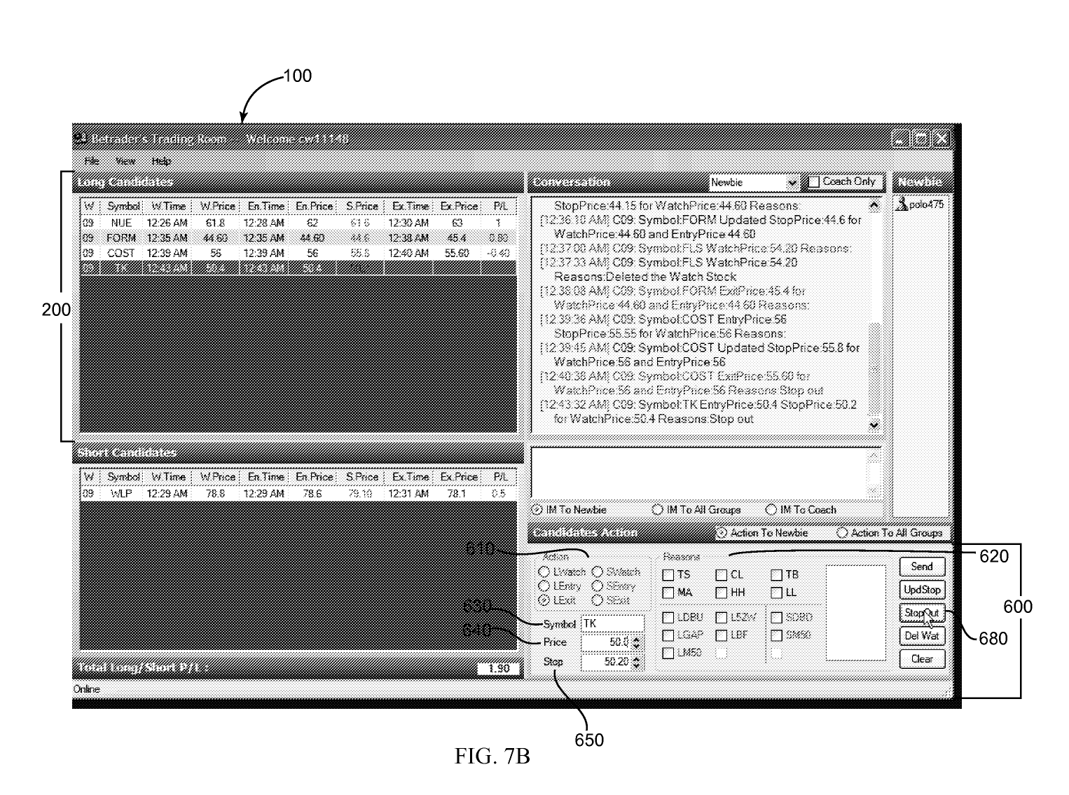

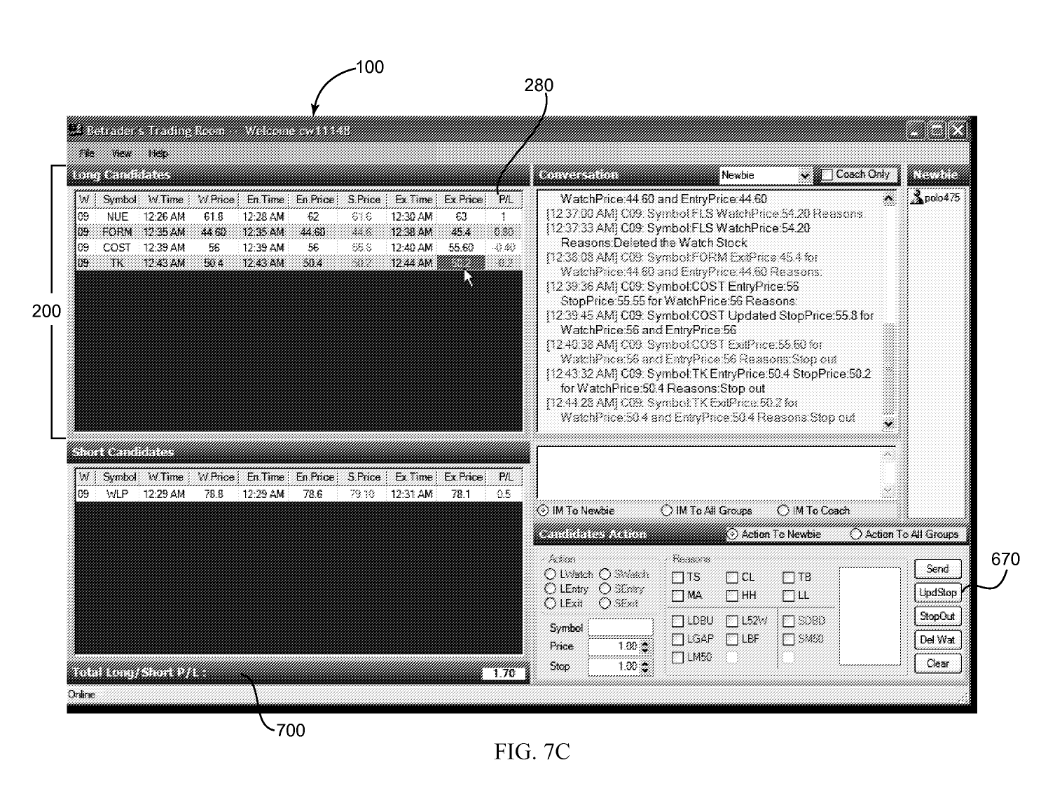

FIG. 7A to 7C are screenshots of the trading room 100 illustrating exiting a long position according to an embodiment of the present invention. After watching the behavior of a long position, a coach or a student may decide to exit the long position. A user may initiate exiting a long position by selecting the listing for a specific long position in long candidates box 200. Upon selecting, all information of the specific long position in long candidates box 200 is highlighted; action box 610 of candidates action box 600 automatically selects LExit. The user provides an exit price, the sales price of the specific long position, in price box 640 and selects send button 660 in order to make a transaction and display the transaction in long candidates box 200.

FIG. 7A is a screenshot of the trading room 100, which resulted from selecting send button 660. As illustrated in long candidates box 200, this particular embodiment of the present invention provides the following information in addition to the information provided in FIG. 4C—Ex.Time 260 for an exit time when the position for the specific stock price was exited in long candidates box 200; Ex.Price 270 for an exit price of the specific candidate stock; P/L 280 for a profit or loss index of the specific transaction.

FIG. 7B illustrates how to exit a long position in order to minimize a loss according to an embodiment of the present invention. When a long position reaches the stop price that was previously set, a coach or a student may decide to exit the position. A user can initiate exiting by selecting the listing for a specific entry candidate in long candidates box 200 and selects a “stopout” button 680 in order to make a stop out transaction and display the transaction in long candidates box 200. In another embodiment of the present invention, once a long position reaches the stop price, the position is automatically exited thus making a stop out transaction without any action by the user.

FIG. 7C is a screenshot of the trading room 100, which resulted from selecting “stopout” button 680. As illustrated in long candidates box 200, the information regarding the stop out transaction entered is displayed along with a profit loss index showing a loss of 20 cents in P/L 280.

In an embodiment of the present invention, total profit/loss box 700 automatically calculates the total profit or loss of all transactions made in long candidates box 200 and short candidates box 300. For example, total profit/loss box 700 of FIG. 7C displays a total profit of $1.70 as a result of four transactions in long candidates box 200 and one transaction in short candidates box 300.

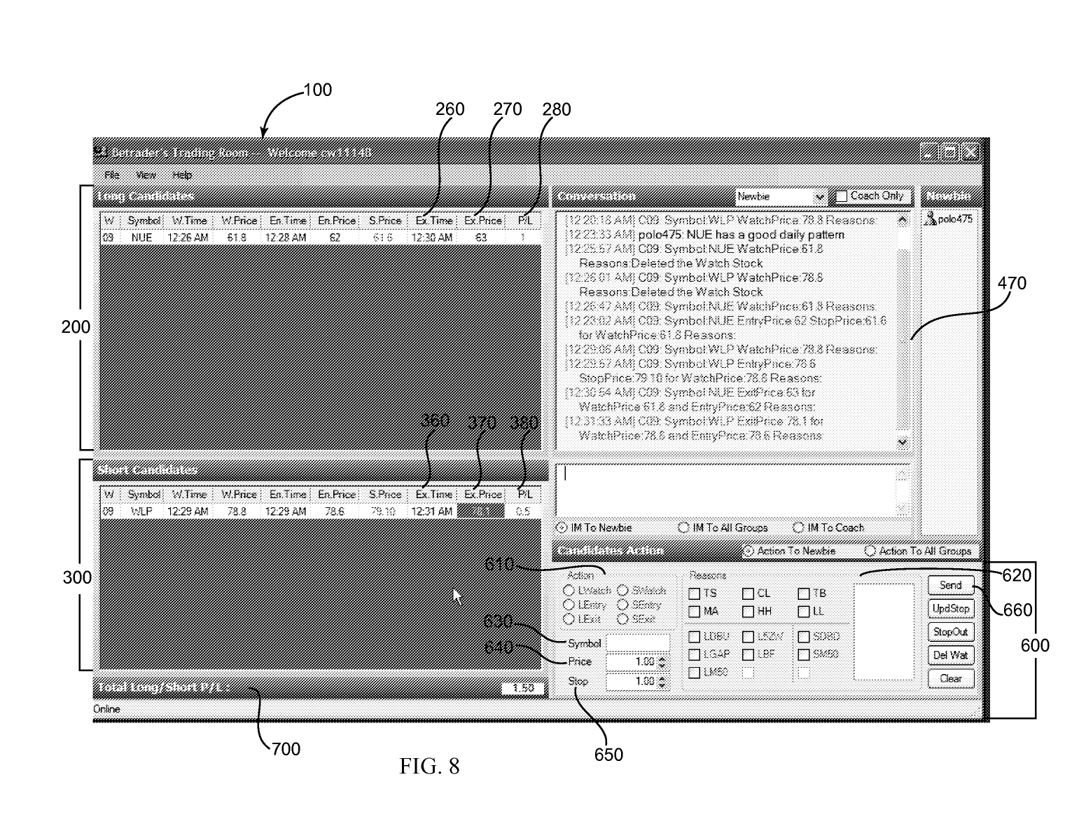

FIG. 8 is a screenshot of the trading room 100 illustrating exiting a short position according to an embodiment of the present invention. After watching the behavior of a short position, a coach or a student may decide to exit the short position. A user may initiate exiting a short position by selecting the listing for a specific entry candidate in short candidates box 300. Upon selecting, all information of the specific position in short candidates box 300 is highlighted; action box 610 of candidates action box 600 displays SExit automatically selected. The user provides an exit price, the purchase price of the specific short candidate, in price box 640 and selects send button 660 in order to make a transaction and display the transaction in short candidates box 300.

In particular, FIG. 8 is a screenshot of the trading room 100, which resulted from selecting send button 660. As illustrated in short candidates box 300, this particular embodiment of the present invention provides the following information in addition to the information provided in FIG. 6B—Ex.Time 360 for an exit time when the position for the specific stock price was exited in short candidates box 300; Ex.Price 370 for an exit price of the specific candidate stock; P/L 380 for a profit or loss index of the specific transaction. Total profit/loss box 700 of FIG. 8 displays a total profit of $1.50 as a result of exiting the short position for the stock WLP.

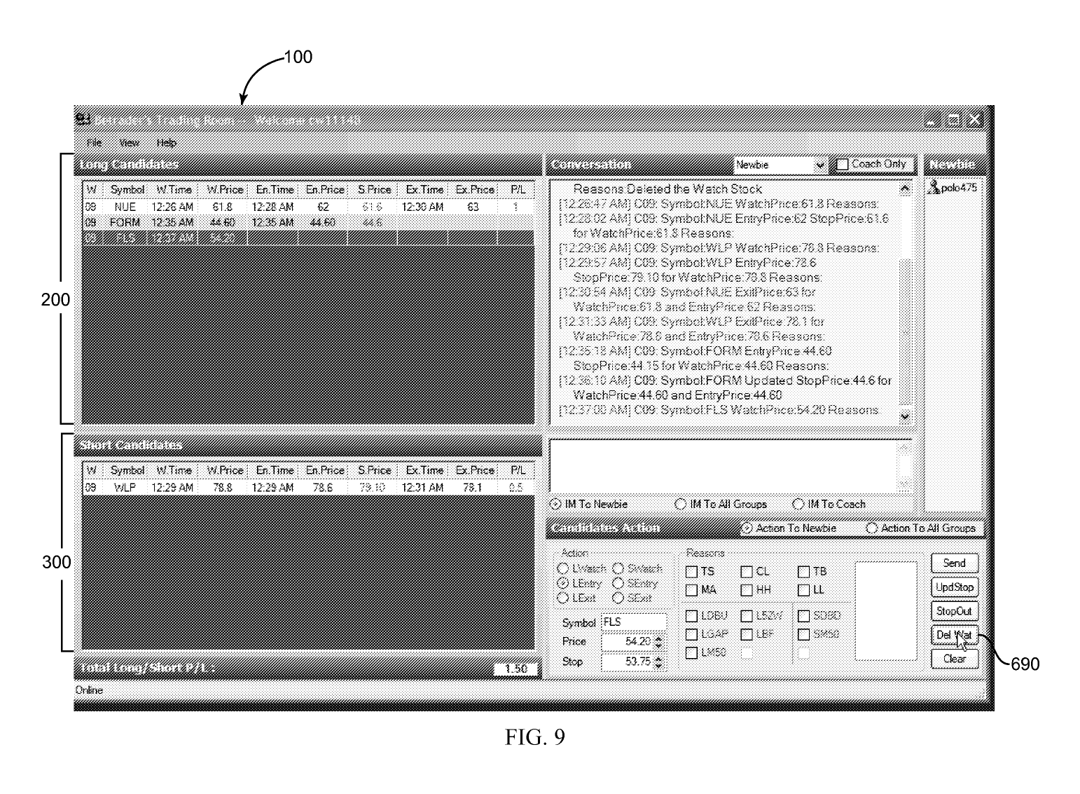

FIG. 9 is a screenshot of the trading room 100 illustrating deleting a listing of a watch candidate according to an embodiment of the present invention. For example, as illustrated in FIG. 9, a user may decide to delete a listing of a watch candidate after watching the candidate's behavior. The user may select the listing for a specific watch candidate in long candidates box 200 or short candidates box 300. As shown in FIG. 4A, the user selects a del wat button 690 in order to delete the listing of the specific watch candidate.

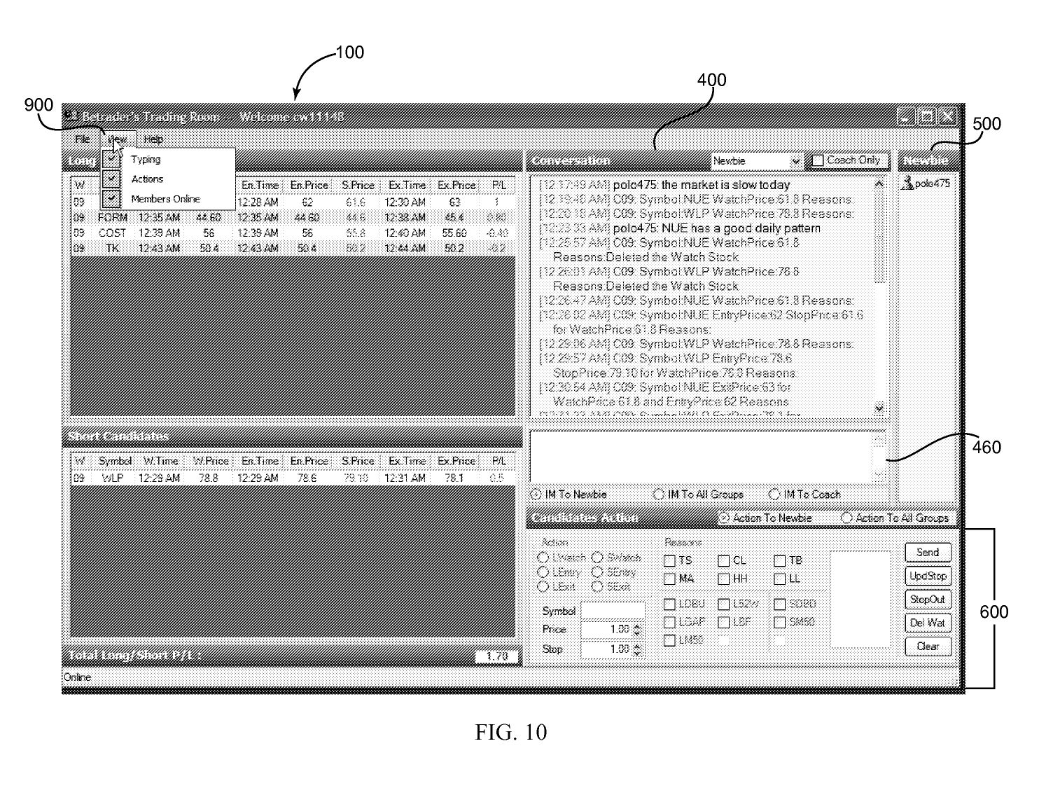

FIG. 10 is a screenshot of the trading room 100 illustrating how to change views according to an embodiment of the present invention. Due to limited screen space or for convenience, a user may decide to hide some boxes. This embodiment of the present invention allows a user to hide entry box 460 by unchecking “typing” using a drop down box under view 900, candidates action box 600 by unchecking actions, and/or members online box 500 by unchecking members online.

An embodiment of the present invention is a trading software to provide an actual buy/sell transaction. In actual trading, a market price of each candidate may be automatically inserted according to a specific time of trading.

Although the present invention has been described in considerable detail with reference to certain preferred versions, other versions are possible. For example, any number of different kinds of users with different objectives of using the present invention may be added and the invention may include a layout that is different from the layout shown in the drawings. Furthermore, the present invention may allow for different ways of making transactions. Therefore, the sprit and scope of the appended claims should not be limited to the description of the preferred versions contained therein.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. All changes that come within the meaning and range of equivalents within the claims are intended to be considered as being embraced within the spirit and scope of the claims.

What is claimed is:

1. A computer implemented method for a trading room connected to a network, the method comprising the steps of:
providing an interface between a user and the computer;
presenting the user with at least one action, selected from action types comprising listing a candidate in a candidate display area, entering a position for the candidate, exiting a position for the candidate, and deleting the candidate listed;
recording the action selected by the user in the candidate display area;
providing a simultaneous instant message capability for the user to share information with another user; and
displaying an instant message on the interface.

2. The method according to claim 1, further comprising the step of:
designated at least one user, as either a coach or a student, wherein the coach is permitted to demonstrate trading and sharing of information, and wherein the student is permitted to participate in trading and sharing of information.

3. The method according to claim 2, wherein the candidate comprises a long candidate and a short candidate; the candidate display area comprises a long candidate display area and a short candidate display area, wherein, for the long candidate, the action is recorded in the long candidate display area, and, for the short candidate, the action is recorded in the short candidate display area; and the position comprises a long position and a short position.

4. The method according to claim 2, wherein the action is selected through a candidates action display area; the action is displayed among users on the instant message; and the candidates action display area provides a standardized reasoning for the user to opt in selecting the action.

5. The method according to claim 2, wherein the coach can limit demonstration of a transaction to one of the user types; and the user can limit sending the instant message to one of the user types.

6. The method according to claim 2, wherein the user types further comprise an observer permitted to view trading and shared information; the student is selected from student types comprising a power student and a normal student; a power student is authorized to participate in trading and sharing of information; and a normal student is authorized to share information.

7. The method according to claim 6, further comprising
a plurality of accessible components for the coach and the student to conduct transactions in the trading room,
wherein accessible components of the trading room for the coach and the power student comprise a long candidate display area, a short candidate display area, a conversation display area including an entry display area for entering a message and a message display area for displaying the message, a candidates action display area for listing and taking the action, and a members online display area;
wherein accessible components of the trading room for the normal student comprise the long candidate display area, the short candidate display area, the conversation display area, and the members online display area; and
wherein accessible components of the trading room for the observer comprise the long candidate display area, the short candidate display area, the message display area, and the members online display area.

8. A computer system for a trading room connected to a network including an interface between a user and the system, comprising:
one or more processors for executing commands that direct operations of the computer system;
memory operatively coupled to the one or more processors;
code executing within the one or more processors from the memory that directs the one or more processors to:
provide an interface between a user and a computer system;
provide a candidate display area to record an action selected by the user, wherein the action is selected from action types comprising listing a candidate in the candidate display area, entering a position for the candidate, exiting a position for the candidate, and deleting the candidate listed;
provide a simultaneous instant message capability for the user to share information with another user; and
provide a conversation display area to display an instant message.

9. The system according to claim 8, wherein the code further directs the one or more processors to:
designate the user as either a coach or a student, wherein the coach is permitted to demonstrate trading and sharing of information, and wherein the student is permitted to participate in trading and sharing of information.

10. The system according to claim 9, wherein the candidate comprises a long candidate and a short candidate; the candidate display area comprises a long candidate display area and a short candidate display area, wherein, for the long candidate, the action is recorded in the long candidate display area, and, for the short candidate, the action is recorded in the short candidate display area; and the position comprises a long position and a short position.

11. The system according to claim 9, wherein the code further directs the one or more processors to:
provide a candidates action display area for the user to select the action; and
provide the instant message for the action to be displayed among users; wherein the candidates action display area provides a standardized reasoning for the user to opt in selecting the action.

12. The system according to claim 9, wherein the coach can limit demonstration of a transaction to one of the user types; and the user can limit sending the instant message to one of the user types.

13. The system according to claim 9, wherein the system is operable in an online condition.

14. The system according to claim 9, wherein the user types further comprise an observer permitted to view trading and shared information; the student is selected from student types comprising a power student and a normal student; a power student is authorized to participate in trading and sharing of information; and a normal student is authorized to share information.

15. The system according to claim 14, wherein the code further directs the one or more processors to provide a plurality of accessible components for the coach and the student to conduct transactions in the trading room
wherein accessible components of the trading room for the coach and the power student comprise a long candidate display area, a short candidate display area, a conversation display area which includes an entry display area for entering a message and a message display area for displaying the message, a candidates action display area for listing and taking the action, and a members online display area;
wherein accessible components of the trading room for the normal student comprise the long candidate display area, the short candidate display area, the conversation display area, and the members online display area; and
wherein accessible components of the trading room for the observer comprise the long candidate display area, the short candidate display area, the message display area, and the members online display area.

16. A computer-readable medium encoded with a computer program having computer-executable instructions configured to:
provide an interface between a user and a computer system;
provide a candidate display area to record an action selected by the user, wherein the action is selected from action types comprising listing a candidate in the candidate display area, entering a position for the candidate, exiting a position for the candidate, and deleting the candidate listed;
provide a simultaneous instant message capability for the user to share information with another user;
provide a conversation display area to display an instant message; and
designate the user as either a coach or a student,
wherein the coach is permitted to demonstrate trading and sharing of information, and
wherein the student is permitted to participate in trading and sharing of information.

17. The medium according to claim 16, wherein the candidate comprises a long candidate and a short candidate; the candidate display area comprises a long candidate display area and a short candidate display area, wherein, for the long candidate, the action is recorded in the long candidate display area, and, for the short candidate, the action is recorded in the short candidate display area; and the position comprises a long position and a short position.

18. The medium according to claim 16, wherein the computer program is further configured to:
provide a candidates action display area for the user to select the action; and
provide the instant message for the action to be displayed among users;
wherein the candidates action display area provides a standardized reasoning for the user to opt in selecting the action.

19. The medium according to claim 16, wherein the coach can limit demonstration of a transaction to one of the user types; and the user can limit sending the instant message to one of the user types.

20. The medium according to claim 16, wherein the user types further comprise an observer permitted to view trading and shared information; the student is selected from student types comprising a power student and a normal student; a power student is authorized to participate in trading and sharing of information; and a normal student is authorized to share information.
